(19) United States
(12) Patent Application Publication
(10) Pub. No.: US 2010/0052319 A1
(43) Pub. Date: Mar. 4, 2010

(54) Dual Seal Expandable Tubular Connection

(75) Inventors: Scott A. Benzie, Houston, TX (US); Andrei G. Filippov, Houston, TX (US)

Correspondence Address: Tod T. Tumey, P.O. BOX 22188, HOUSTON, TX, 77227-2188, US

(73) Assignee: MOHAWK ENERGY LTD., Houston, TX (US)

(21) Appl. No.: 12/200,518

(22) Filed: Aug. 28, 2008

(51) Int. Cl. F16L 13/14

(52) U.S. Cl. 285/382.2

(57) ABSTRACT

The present invention provides an expandable tubular connection that may be expanded to large degrees of expansion (i.e., 15-25%) in highly constrained conditions, such as Fix-Fix conditions, by hydraulic means and produces a metal-to-metal seal after expansion. The expandable tubular connection incorporates a combination of elastomeric and metal-to-metal sealing components in the sealing system. The elastomeric sealing component provides sealing of the connection during hydraulic expansion and allows control of deformation rates of pin and box members to achieve a high stress interference contact between pin and box members resulting in a metal-to-metal seal after expansion.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

This invention relates to the field of tubular connections and more specifically to a dual seal system for expandable tubular connections.

2. Background of the Invention

Radially expandable tubulars are typically used in well bore operations during well construction, well drilling, and well repair. During such well bore operations, the tubulars are often radially expanded in-situ. In-situ radial expansion of tubulars may allow minimization of well bore diameter loss. Such in-situ expansion may also allow isolation of low or high pressure areas in the well bore with no reduction in well bore diameter or a minimum reduction in well bore diameter.

Radially expandable tubulars include casing joints, liners and other oilfield tubulars. The radially expandable tubulars are typically connected by threaded connections in an end-to-end manner or by couplings. The threaded connections may be designed to provide mechanical integrity between the joints and a seal, which may be disposed between the interior and exterior of the tubular.

Conventional methods of radial expansion of the tubular may use a conical cone propelled through the tubular by hydraulic pressure, usually referred to as the hydraulic method, or by mechanical means such as a thruster. The hydraulic method is often used for tubular expansion of long strings of tubulars. In some instances, an internal pressure seal in oilfield applications includes a metal-to-metal gas tight seal, which provides a reliable seal with regard to its longevity and environmental resistance. Expandable connections with metal-to-metal seals may be expanded by mechanical means.

For instance, FIG. 1A shows an expansion of tubular 101, having original inside diameter Do. The expansion is accomplished by propagating an expansion cone 102 through the tubular 101 by a mechanical means. The mechanical means is defined as a system capable of providing a force F suitable for propagating expansion cone 102 through tubular 101 providing that pressures inside and outside the expanded portion 103 of tubular 101 are substantially equal. Without limitation, examples of mechanical means include systems generating force F by pulling or pushing expansion cone 102 by drill pipe, coiled tubing, or hydraulic, electrical, or mechanical thrusters. In some embodiments, the expansion is plastic radial expansion. The plastic radial expansion of tubular 101 may be measured in a percentage of permanent increase in tubular internal diameter after expansion, Dm, relative to the original inside diameter, Do (i.e., internal tubular diameter before expansion). Depending on a particular well geometry, plastic radial expansion of tubular 101 may be in the range from about 5% to about 40%.

As shown in FIG. 1A, it has been found that expanded portion 103 has a Dm larger than the cone diameter Dc. This difference between Dm and Dc is referred to as surplus expansion. Without being limited by theory, the surplus expansion may be due to the bending effects in the region 104 where the tubular 101 is coming off expansion cone 102. The degree of surplus expansion depends on the cone angle, a. In embodiments, the surplus expansion is larger for large angles and smaller for small angles. In an embodiment, the cone angle, a, is not less than 5 degrees. Without being limited by theory, cone angle, a, is not less than 5 degrees because at smaller angles friction force between expansion cone 102 and tubular 101 becomes prohibitively high for the expansion process. It has been found that expanded portion 103 has a positive surplus expansion when expanded with cones having an angle above 5 degrees.

It has been also found that tubular 101 has a negative surplus expansion at its free end 105 (i.e., the internal diameter De at free end 105 is less than Dc). At free end 105, tubular 101 is bent inward over the area of length 106 in a longitudinal direction. This effect also relates to the bending effects in tubular 101, and the negative surplus expansion at free end 105 is always present when the main part of expanded portion 103 has positive surplus expansion. The length 106 of the inward bent area is approximately 2 to 3 times the tubular wall thickness 107.

FIG. 1B illustrates an embodiment of another method of expanding casing or tubular inside a wellbore using hydraulic means. The pre-expanded portion 110 of tubular 101 has a seal 112, and expansion cone 102 is propelled by a hydraulic means. Hydraulic means is disclosed in U.S. Pat. No. 6,085,838, which is incorporated by reference in its entirety. The hydraulic means is defined as a system providing a force suitable for propagating expansion cone 102 through tubular 101 provided that pressure inside the expanded portion 103 of tubular 101 is substantially higher than pressure outside expanded portion 103 of tubular 101. Without limitation, examples of hydraulic means include systems generating force suitable for propagating expansion cone 102 by applying pressure directly to the cone or to seal cups in front or in back of the expansion cone 102. The pressure fluid may be supplied from the surface through a drill pipe or a coiled tubing (not shown), or by electrical or mechanical submersible pumps. Without being limited by theory, it has been found both through experimentation and Finite Element Analysis (FEA) that in the case of expansion by hydraulic means, the surplus expansion is higher than the surplus expansion when the same tubular 101 is expanded by mechanical means using the same shape expansion cone 102 of the same Dc. The inner diameter, Dp, of the tubular 101 expanded by hydraulic means is larger than the Dm of the tubular 101 expanded by mechanical means. This effect is also related to the bending of the tubular 101 at the end of its expansion over the expansion cone 102 in the area nearest to the expansion cone 102 maximum Dc. In the case of expansion by mechanical means, a certain bending moment suitable for rotating tubular cross-section by the angle, a, is generated by the additional plastic radial expansion of the tubular 101 resulting in a certain surplus expansion. In the case of expansion by hydraulic means, pressure, p, applied to the inner part of expanded portion 103 of tubular 101 is acting as a distributed load in the direction opposite to the forces generating the bending moment, and therefore additional plastic deformation in the radial direction is desired, which results in additional surplus expansion.

Drawbacks with expansion of metal-to-metal seal connections include problems with high degrees of expansion using the hydraulic method. For instance, during expansion by hydraulic pressure, the portion of the pin nose between the seal area and a free end of the pin nose is under hydrostatic pressure with other portions of the connection under internal pressure, which may affect relative radial displacements of pin and box seal surfaces resulting in loss of interference contact between pin and box seal surfaces and failure of the expansion process.

For instance, FIG. 2A shows a fragmentary sectional view of a conventional expandable tubular connection 120 in an unexpanded state. Expandable tubular connection 120 comprises a pin member 121 and a box member 122, each of which has threads 123 formed thereon. Pin member 121 comprises a non threaded portion, so called pin nose 126, which is disposed between threads 123 and pin nose free end 125. Box member 122 also has a non threaded portion disposed radially opposite to pin nose 126. As shown in FIGS. 2A and 2B, the non threaded portion of the box member 122 comprises a “strain focusing groove” 124 designed to produce an interference contact 127 between box member 122 and pin nose 126 upon radial expansion of the connection resulting in a metal-to-metal seal. It should be noted that the radial expansion of the connection causes pin nose 126 to shorten, thereby causing pin nose free end 125 to “retract” from the back of the box 129 for some distance 128. The retraction of the end of the pin nose 126 is typically due to the difference in stress conditions in the box member 122 and in the pin nose 126 during the expansion process. The box member 122 is stretched over the expansion cone in the longitudinal direction, while the pin nose 126 has a pin nose free end 125, and therefore it shrinks significantly more than the corresponding unthreaded area of the box member 122. The end of the pin nose 126 also bends inward in the same manner and for the same reasons as the free end of an expanded plain-end pipe.

The expandable tubular connection 120, when properly designed, is capable of providing a metal-to-metal seal when expanded by mechanical means. However, expansion of the metal-to-metal seal connections 120 by hydraulic means is typically problematic. For instance as shown in FIG. 2C, during expansion by hydraulic means, the end portion 132 of the pin nose 126 between the free end 135 and contact point 130 (i.e., the cross-hatched area) is under hydrostatic pressure. Therefore, the end portion 132 is being expanded by expansion cone 133 in the same way as in the case of expansion by mechanical means, while the rest of the expandable tubular connection 120 is under internal pressure, p. As discussed above, the surplus expansion of the tubular 101 expanded under internal pressure is higher than the surplus expansion of the tubular 101 expanded by mechanical means. Since the end portion 132 of the pin nose 126 is expanded mechanically, surplus expansion of end portion 132 is less than the surplus expansion of box member 122, which results in loss of interference contact between the pin nose 126 and contact point 130. As a result, the seal between contact point 130 and the pin nose 126 is lost, expandable tubular connection 120 may start leaking, and the expansion process may come to a halt.

Another conventional metal-to-metal seal design of an expandable connection includes a pin nose of the connection having a tongue that projects axially with the back of the box having a receiving groove. The tongue is engaged in the receiving groove upon make-up of the connection, which creates a seal between the tongue and groove during radial expansion of the connection due to the inward bending effect of the free end of the pin nose (i.e., for the same reason as the free end of a plain-end tubular). This allows expansion by hydraulic means of the tongue and groove connection. However, such expansion is only to a limited degree (10-15%) of expansion when the tubular is unconstrained. At higher degrees of expansion and especially when the tubular is expanded in Fix-Fix conditions, the tongue and grove disengage, and the seal fails. The Fix-Fix conditions refer to conditions when the tubular is constrained from longitudinal shrinkage. For instance, the constraint is due to differential sticking of the tubular to the well bore or to the packing of the annulus between the tubular and wellbore. Under these conditions, during expansion, the tongue is displaced out of the groove due to the higher shrinkage of the pin nose compared to the box member, since the pin nose has a free end and is not constrained from longitudinal shrinkage. Thus, the groove and tongue seal fails at high degrees of expansion and/or when expansion is done in Fix-Fix conditions with the expansion process coming to a halt.

Elastomeric seals have been developed to overcome drawbacks of the metal-to-metal seals. Connections with elastomeric seals may be expanded using hydraulic pressure because the resilience of the elastomeric element, such as an O-ring, provides significantly higher tolerance with regard to relative displacements of pin nose and box than a metal-to-metal seal. Drawbacks to elastomeric seals include that elastomeric seal connections are typically less reliable than metal-to-metal seal connections with regard to longevity, temperature, and environmental resistance.

Expandable metal-to-metal seal designs for threaded tubular connections have been developed that in addition to a metal-to-metal seal to augment sealing capability of the connections, a resilient elastomeric seal is placed in the back of the box member at the free end of the pin nose. Drawbacks include that upon radial plastic expansion of the connection the pin nose pulls away from the back of the box both in the longitudinal and radial directions (see FIGS. 2B and 2C), and the resulting gap between the end portion of the pin nose and the back of the box “de-energizes” the elastomeric seal causing the seal to fail. In effect, the radial expansion may disable the elastomeric seal positioned at the end of pin nose, and therefore the end portion of the pin nose in the case of expansion by hydraulic means becomes under hydrostatic pressure as shown in FIG. 2C, which causes loss of the interference in metal-to-metal seal, leaking of the connection, and expansion by hydraulic means comes to a halt.

Alternatively, elastomeric seals designed for expandable connections have been shown to be capable of providing hydraulic seals during and after expansion by hydraulic means of tubulars including large degrees of expansion and in Fix-Fix conditions. The elastomeric seals do not require stress interference contact between pin and box members of the connection. The distance between the elastomeric seal groove and the pin nose free end, and the size of the elastomeric element may be selected such that the elastomeric element remains to be compressed between pin and box members even when pin and box members are separated by a certain annulus developed between pin and box members due to the difference in overexpansion related to the difference in conditions of expansion of box and pin members. However, drawbacks of elastomeric seals for expandable connections include their long term durability. After connection expansion, the elastomeric sealing element is stretched, which in combination with high pressure of aggressive environments such as oil or gas may cause deterioration of elastomeric element in a short period of time.

Consequently, there is a need for an improved sealing system for expandable connections that would allow a high degree of tubular expansion by the hydraulic method and provide a reliable metal-to-metal seal after expansion. Needs include an internal pressure seal in oilfield applications with a metal-to-metal gas-tight seal, which is significantly more reliable and resistant to harsh environmental conditions than elastomeric seals. Additional needs include an expandable tubular connection that may be expanded to large degrees of expansion (15-25%) in highly constrained conditions, such as Fix-Fix conditions, by hydraulic means and that produces a metal-to-metal seal after expansion. The seal may be achieved by incorporating a combination of elastomeric and metal-to-metal sealing components in the sealing system of an expandable connection. The elastomeric sealing component provides sealing of the connection during expansion by hydraulic means and allows control of deformation rates of pin and box members to achieve a high stress interference contact between pin and box members resulting in metal-to-metal seal after expansion.

### BRIEF SUMMARY OF SOME OF THE PREFERRED EMBODIMENTS

An expandable tubular connection with an internal sealing system that allows a high degree of tubular expansion by the hydraulic method and also provides a metal-to-metal seal after plastic radial expansion is disclosed. The tubular connection includes a pin member comprising external threads, a non threaded surface, and a free end. The non threaded surface is disposed between the free end and the external threads. The tubular connection also includes a box member comprising internal threads. The internal threads are threadably engaged with the external threads. In addition, the tubular connection has a sealing system comprising a metal-to-metal sealing component and an elastomeric sealing component. The metal-to-metal sealing component is disposed between the pin nose free end and the threadably engaged external and internal threads. The elastomeric sealing component is disposed between the metal-to-metal sealing component and the pin nose free end. The elastomeric sealing component is capable of providing a hydraulic seal during expansion of the connection by the hydraulic method (i.e., when the expansion cone is propelled by hydraulic pressure), and the metal-to-metal sealing component is capable of providing a metal-to-metal seal after radial expansion of the connection.

In an alternative embodiment, the metal-to-metal sealing component comprises a protuberance formed in the box member, and the elastomeric sealing component comprises a dove-tail shape groove formed in the box member and an elastomeric sealing ring disposed in the groove. It has been experimentally demonstrated that the expandable tubular connection may be successfully expanded by the hydraulic method to the degree of 20% higher than its original diameter providing a high pressure metal-to-metal seal after expansion.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other embodiments for carrying out the same purposes of the present invention. It should also be realized by those skilled in the art that such equivalent embodiments do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1A illustrates a partial cross sectional side view of a plain-end tubular expanded by an expansion cone propelled through the tubular mechanically;

FIG. 1B illustrates a partial cross sectional side view of a plain-end tubular expanded by an expansion cone propelled through the tubular hydraulically;

FIG. 2A illustrates a partial cross sectional side view of a conventional metal-to-metal expandable tubular connection prior to expansion;

FIG. 2B illustrates a partial cross sectional side view of a conventional metal-to-metal expandable tubular connection shown in FIG. 2A after being expanded mechanically;

FIG. 2C illustrates a partial cross sectional side view of a conventional metal-to-metal expandable tubular connection shown in FIG. 2A being expanded hydraulically;

FIG. 3A illustrates a partial cross sectional side view of an expandable threaded connection prior to expansion;

FIG. 3B illustrates a partial cross sectional side view of an expandable threaded connection prior to expansion; and

FIG. 3C illustrates a partial cross sectional side view of the expandable threaded connection shown in FIG. 3A being expanded hydraulically.

### DETAILED DESCRIPTION OF THE PREFERRED EMBODIMENTS

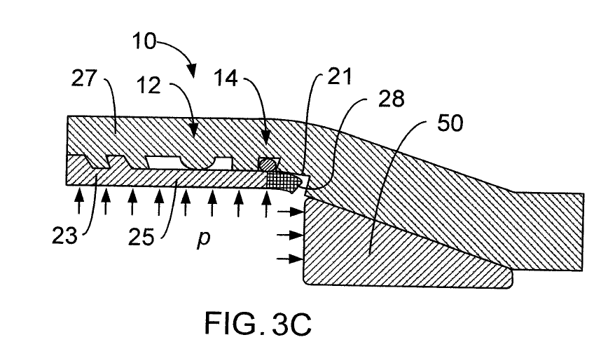

FIG. 3A illustrates an embodiment showing a fragmentary sectional view of expandable tubular connection 10 in an unexpanded state. The expandable tubular connection 10 includes a pin member 23 and a box member 27 having pin threads 11 (i.e., external threads) and box threads 75 (i.e., internal threads), respectively, formed thereon. Pin member 23 comprises pin nose 25, which is a non threaded portion disposed between pin threads 11 and pin nose free end 28. Box member 27 also has a non threaded portion disposed radially opposite to pin nose 25. In an embodiment as illustrated in FIG. 3A, expandable tubular connection 10 comprises a metal-to-metal sealing component 12 positioned next to the pin threads 11 and box threads 75, and an elastomeric sealing component 14 positioned between the metal-to-metal sealing component 12 and the pin nose free end 28. Expandable tubular connection 10 may be radially expandable by mechanical means or by hydraulic means in different conditions, including Fix-Fix conditions.

The metal-to-metal sealing component 12 is defined as any metal-to-metal seal suitable for expandable tubular connections provided that it generates a metal-to-metal seal when the connection is expanded by mechanical means. Without limitation, examples of suitable metal-to-metal sealing components include metal-to-metal seals disclosed in U.S. Pat. No. 6,607,220; U.S. Patent Application Publication No. 2007/0035130; and U.S. Patent Application Publication No. 2007/0035131, which are each incorporated by reference herein in its entirety.

The elastomeric sealing component 14 is defined as any elastomeric seal suitable for expandable tubular connections provided that it provides an elastomeric seal during and after expansion by hydraulic means. Without limitation, examples of suitable elastomeric sealing components include elastomeric seals disclosed in U.S. Pat. No. 6,409,175 and U.S. Patent Application Publication No. 2007/0257486, which are each incorporated by reference herein in its entirety.

The threads 11, 75 may be selected from a broad range of thread types used in the industry. Without limitation, examples of suitable threaded configurations include hooked type threads, wedge threads, tapered threads, non-tapered threads, square threads, and dovetail-shaped threads. When the expandable connection is made up, pin nose free end 28 and box surface 40 located at the back of the box 34 are in contact or nearly in contact.

As it was previously discussed, during radial expansion of the conventional connection, the pin nose free end 28 pulls away from the back of the box 34 both in axial and radial directions. To accommodate for these effects, it was found through Finite Elemental Analysis (FEA) that to minimize separation between the pin nose 25 and sealing element 39 (such as an elastomeric O-ring), the elastomeric sealing component 14 may be positioned at a minimum distance 46, as shown in FIG. 3B, from the pin nose free end 28 of about 2.5 to about 3.5 times the pin nose thickness 47.

FIG. 3C shows a cross-sectional view of expanded expandable tubular connection 10, which comprises the elastomeric sealing component 14 and the metal-to-metal sealing component 12. The expansion of the expandable tubular connection 10 by expansion cone 50 is accomplished by hydraulic means. The end portion of the pin nose 20 (cross hatched area, see FIG. 3C, between the elastomeric sealing component 14 and the pin nose free end 28) is under hydrostatic pressure and retracts from the end portion of the box member 21 both in radial and in axial directions. As shown in FIG. 3B, by positioning elastomeric sealing component 14 from the pin nose free end 28 at the distance of about 2.5 to about 3.5 times the pin nose thickness 47, the radial displacement of the pin nose 25 from the box member 27 at the location of the elastomeric sealing component 14 is minimized. The size of the groove 38 and the size of the sealing element 39 are selected such that the elastomeric sealing component 14 remains to be compressed by the pin nose 25 and maintains the pressure seal. Thus, the pin member 23 including the pin nose portion between the elastomeric sealing component 14 and the pin threads 11 is under internal pressure as well as the box member 27 (i.e., since the pressure is transmitted to the box member 27 through the contact areas between pin and box members 23, 27). Therefore, the pin nose portion opposite to the metal-to-metal sealing component 12 has the same degree of overexpansion as the box member 27. Having the same degree of overexpansion of box and pin members 27, 23 results in the same conditions as in the case of expansion by mechanical means, and therefore a metal-to-metal sealing component 12 capable of generating a seal in case of expansion by mechanical means produces a seal under expansion by hydraulic means. Thus, introduction of elastomeric sealing component 14 in front of the metal-to-metal sealing component 12 allows successful expansion by hydraulic means of the expandable tubular connection 10 and creation of a metal-to-metal seal after expansion.

In an embodiment, the pin nose 25 has a substantially cylindrical shape with pin nose thickness 47, as shown in FIGS. 3A and 3B. Pin nose 25 also has an axial length defined as a distance between pin threads 11 and pin nose free end 28. The metal-to-metal sealing component 12 comprises a non threaded portion of the box member 27 and a protuberance 37. Protuberance 37 may employ different geometries provided that it has a single tip 33 in a radial direction. In embodiments, protuberance 37 comprises a positive curvature and has a profile (i.e., when viewed in section as shown in FIG. 3A) that is substantially circular or elliptical in nature. The protuberance 37 defines unsupported areas 35 and 36 (i.e., areas of the box member 27 that are not in contact with pin nose 25). As shown in FIG. 3B, the protuberance axial length 43 is defined as a total axial length of axial lengths of unsupported areas 35 and 36 including a small contact area under the tip 33 of protuberance 37. The protuberance depth 41 is defined as a maximum distance between an unsupported area (35 or 36) of the protuberance 37 and the outer pin nose surface 15 in a radial direction. The shape and the dimensions of the protuberance 37 are selected to generate stress interference between the protuberance tip 33 and the pin nose 25 upon plastic radial expansion of the expandable tubular connection 10 to provide a metal-to-metal seal after the radial expansion force is removed from the expandable tubular connection 10. The high stress interference between the tip 33 of protuberance 37 and the pin nose 25 is developed due to the additional force suitable for plastic radial expansion of the unsupported areas 35 and 36 of the box member 27. In some embodiments, for practical reasons and ease of manufacturing, the protuberance depth 41 is selected to be substantially equal to height 42 of the threads 11, 75. It has been found through experimentation and FEA modeling that high stress interference at the tip 33 of protuberance 37 is developed upon plastic radial expansion of expandable tubular connection 10 when the ratio of protuberance axial length 43 to the box radial thickness 44 above the protuberance 37 is in the range between about 1.5 and about 3.5, and the tip 33 of protuberance 37 is positioned substantially in the middle of protuberance 37 is in the longitudinal direction.

In an embodiment as shown in FIG. 3A, the elastomeric sealing component 14 of expandable tubular connection 10 comprises groove 38 in the box member 27 and also sealing element 39 (i.e., elastomeric sealing element). The groove 38 has a “dovetail” type configuration, which shape and relative dimensions are disclosed in U.S. Patent Application Publication No. 2007/0257486 and which is incorporated by reference in its entirety. The sealing element 39 may have different cross-sectional shapes provided that the sealing element 39 cross-sectional dimension in the radial direction is about 1.15 to about 1.55 times larger than depth 49 of groove 38 in the radial direction, as shown in FIG. 3B. The elastomeric sealing component 14 is positioned at distance 46 from pin nose free end 28 equal to about 2.5 to about 3.5 times the pin nose thickness 47. It was also found through FEA that for obtaining high stress interference between the tip 33 of the protuberance 37 and the pin nose 25, during expansion by hydraulic means, the distance 45 between sealing element 39 and the protuberance 37 is at least about 1.2 times the pin nose thickness 47.

To further illustrate various illustrative embodiments, the following examples are provided.

### EXAMPLES

Expandable tubular connections (i.e., with reference to FIG. 3B for illustrative purposes) were manufactured using an API grade L-80 tubular with an external diameter of 7.625 in. and nominal wall thickness 48 of 0.375 in.

The geometry of the connections was as follows:

tapered threadings 11, 75 (taper=7% over diameter) with trapezoidal threads with a radial height 41 of 0.050 in. and an axial pitch of 0.200 in.;

pin nose 25 of cylindrical shape with radial thickness 47 of 0.095 in.;

metal-to-metal sealing component 12 with a protuberance having a radius of curvature at the tip 33 of 0.2 in., radial depth 41 of 0.050 in., axial length 43 of 0.630 in., and box radial thickness 44 above protuberance of 0.237 in.; and

elastomeric sealing component 14 having a half dovetail groove with a depth 49 of 0.052 in., an elastomeric O-Ring (sealing element 39) with cross-sectional diameter of 0.070 in., and positioned from the protuberance 37 at distance 45 of 0.150 in., and from the pin nose free end 28 at distance 46 of 0.250 in.

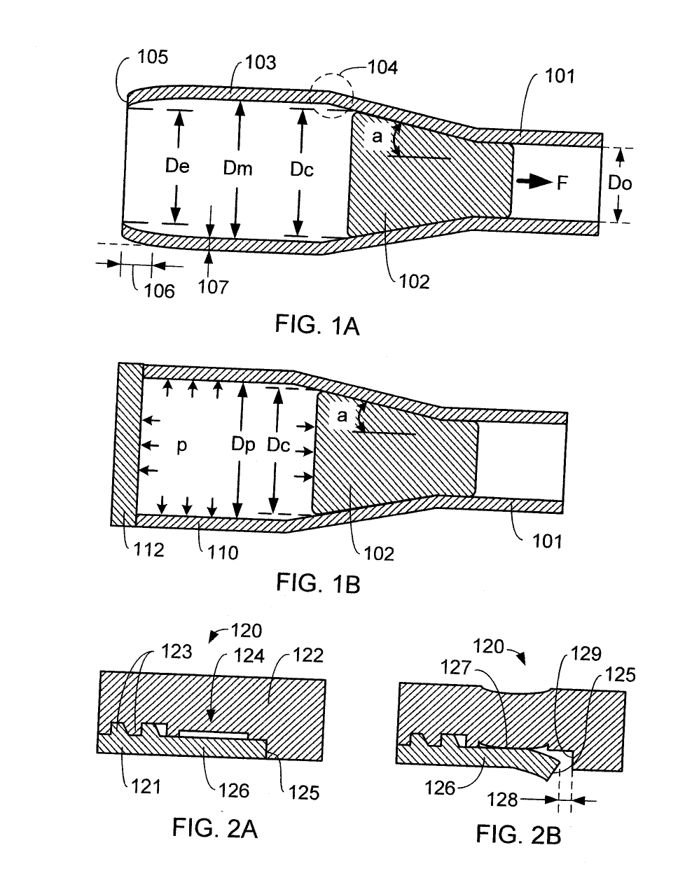

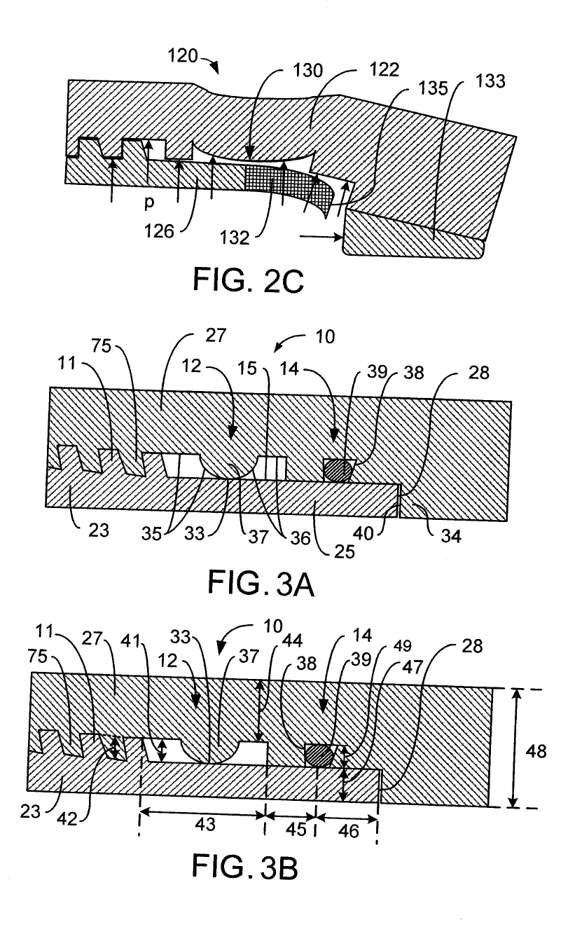

The expansion tool was a conically tapered expansion cone with tapering angle (i.e., reference, a, of FIG. 1B) of 10 degrees with a cone diameter Dc=8.25 in.

### Test 1.

Several tubulars connected together by expandable tubular connections 10 having the geometry described above were successfully expanded by applying water pressure, p, behind the expansion cone (i.e., FIG. 1B for illustration purposes). The expansion was done in Fix-Fix conditions by positioning the expandable tubular inside the pipe with an outside diameter of 10.75 in. and inside diameter of 10.050 in. and welding flanges at both ends of expandable tubular to prevent its longitudinal shrinkage during expansion. The average expansion pressure was 4,500 psi. There was no leakage observed. After expansion, the expanded tubular had a wall thickness of 0.300 in., an outside diameter of 8.877 in., and an inside diameter, Dp, of 8.276 in., which corresponded to an expansion ratio of 20.4%.

After expansion, a hole of 0.1 in. diameter was drilled through the pin nose 25 between the metal-to-metal sealing component 12 and elastomeric sealing component 14 (e.g., approximately 0.3 in. from the pin nose free end 28), which allowed pressurized liquid to bypass the elastomeric seal. Then, the ends of the expanded tubular were enclosed by welded flanges, and internal pressure was applied. There was no leakage through the connection observed up to 5,520 psi, which was slightly higher than the expanded pipe body internal yield pressure calculated as pipe wall thickness divided by outside radius and multiplied by the minimum yield stress (80 ksi) of pipe material. Thus, this test confirmed that expandable tubular connections 10 comprising a metal-to-metal sealing component 12 and an elastomeric sealing component 14 in combination allows successful expansion of the connection by hydraulic means in Fix-Fix conditions and creation of a metal-to-metal seal after expansion.

### Test 2.

This was a control test. The same connection using the same expansion cone was attempted to be hydraulically expanded but without installation of the elastomeric O-Ring. The connection started severely leaking when the free end of the pin nose was coming off the expansion cone, which stalled the expansion process.

Although the present invention and its advantages have been described in detail, it should be understood that various changes, substitutions and alterations may be made herein without departing from the spirit and scope of the invention as defined by the appended claims.

What is claimed is:

1. A tubular connection, wherein the tubular connection is plastically radially expandable, comprising:
a pin member comprising external threads and a pin nose disposed between the external threads and a pin nose free end;
a box member comprising internal threads and a non threaded area opposite to the pin nose, wherein the internal threads are threadably engaged with the external threads;
a metal-to-metal sealing component disposed between the pin nose free end and the threadably engaged external threads and internal threads; and
an elastomeric sealing component disposed between the metal-to-metal sealing component and the pin nose free end,
wherein the elastomeric sealing component provides an elastomeric seal during expansion of the tubular connection, and
wherein the metal-to-metal component provides a metal-to-metal seal after expansion of the tubular connection.

2. The tubular connection of claim 1, wherein the expansion of the tubular connection is accomplished by propelling an expansion cone through the tubular connection.

3. The tubular connection of claim 2, wherein the expansion cone is propelled through the tubular connection by hydraulic means.

4. The tubular connection of claim 2, wherein the expansion cone is propelled through the tubular connection by mechanical means.

5. The tubular connection of claim 1, wherein the tubular connection is plastically radially expanded under Fix-Fix conditions.

6. The tubular connection of claim 1, wherein the elastomeric sealing component is positioned at a distance from the pin nose free end equal to about 2.5 to about 3.5 times a thickness of the pin nose.

7. The tubular connection of claim 1, wherein the elastomeric sealing component comprises a groove formed in the box member, and wherein an elastomeric element is disposed in the groove.

8. The tubular connection of claim 1, wherein an interference contact between the pin nose and the box member is formed during plastic radial expansion of the tubular connection to provide the metal-to-metal seal after radial expansion of the tubular connection.

9. The tubular connection of claim 1, wherein the metal-to-metal sealing component comprises a protuberance, and wherein a ratio of a length of the protuberance to a radial thickness of the box member above the protuberance in an axial direction is between about 1.5 and about 3.5.

10. The tubular connection of claim 1, wherein the metal-to-metal sealing component comprises a protuberance, and wherein a distance between the protuberance and the elastomeric sealing component in an axial direction is at least about 1.2 times a thickness of the pin nose.

11. A tubular connection, wherein the tubular connection is plastically radially expandable, comprising:
a pin member comprising external threads and a pin nose disposed between the external threads and a pin nose free end;
a box member comprising internal threads and a non threaded area opposite to the pin nose, wherein the internal threads are threadably engaged with the external threads;
a metal-to-metal sealing component disposed between the pin nose free end and the threadably engaged external threads and internal threads, wherein the metal-to-metal sealing component comprises a protuberance formed in the box member;
an elastomeric sealing component disposed between the metal-to-metal sealing component and the pin nose free end, wherein the elastomeric sealing component comprises a groove formed in the box member and an elastomeric element disposed in the groove;
wherein the elastomeric sealing component provides an elastomeric seal during expansion of the tubular connection, and
wherein the metal-to-metal component provides a metal-to-metal seal after expansion of the tubular connection.

12. The tubular connection of claim 11, wherein the expansion of the tubular connection is accomplished by propelling an expansion cone through the tubular connection.

13. The tubular connection of claim 12, wherein the expansion cone is propelled through the tubular connection by hydraulic means.

14. The tubular connection of claim 12, wherein the expansion cone is propelled through the tubular connection by mechanical means.

15. The tubular connection of claim 11, wherein the tubular connection is plastically radially expanded under Fix-Fix conditions.

16. The tubular connection of claim 11, wherein the elastomeric sealing component is positioned at a distance from the pin nose free end equal to about 2.5 to about 3.5 times a thickness of the pin nose.

17. The tubular connection of claim 11, wherein the elastomeric sealing component comprises the groove having a dovetail type configuration.

18. The tubular connection of claim 11, wherein an interference contact between the pin nose and the box member is formed during plastic radial expansion of the tubular connection to provide the metal-to-metal seal after radial expansion of the tubular connection.

19. The tubular connection of claim 11, wherein a ratio of the length of the protuberance to a radial thickness of the box member above the protuberance in an axial direction is between about 1.5 and about 3.5.

20. The tubular connection of claim 11, wherein a distance between the protuberance and the elastomeric sealing component in an axial direction is at least about 1.2 times a thickness of the pin nose.
